(19) United States
(12) Patent Application Publication
(10) Pub. No.: US 2006/0166742 A1
(43) Pub. Date: Jul. 27, 2006

(54) Method for advertisement service provider wholesaling

(76) Inventors: Daniel Willis, Stittsville (CA); Dhananjay Godse, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,968

(22) Filed: Dec. 19, 2005

Related U.S. Application Data
(60) Provisional application No. 60/636,545, filed on Dec. 17, 2004.

(51) Int. Cl. A63F 9/24; G06F 19/00

(52) U.S. Cl. 463/42

(57) ABSTRACT

A method for managing advertising content delivery in a gaming environment includes associating a plurality of advertising spots of an advertising enabled game with a first advertising service provider (ADSP). In particular, the first ADSP is in communication with a communications network, such as for instance a wide area network. Using an encryption key, advertising content data is secured from tampering. Then, via the communications network, the secured advertising content data is provided for being impressed within one of the plurality of advertising spots associated with the first ADSP.

### REFERENCE TO PRIOR APPLICATION

This application claims benefit from U.S. Provisional Application No. 60/636,545 filed on Dec. 17, 2004, the entire contents of which is incorporated herein by reference.

### FIELD OF THE INVENTION

The instant invention relates generally to advertising in games on the Internet, and more specifically to a method for allowing advertising service providers to make a portion of their unfilled advertising spots available to other advertising service providers.

### BACKGROUND OF THE INVENTION

During recent years, computer gaming has gained increasing popularity, and today thousands of players are playing games all around the world. Predictably, interactive computer gaming on Internet enabled platforms has blurred the line between games and other entertainment or communication media, and the avenues that are being explored in the development of gaming might well break new ground for interactive Internet applications in all areas of business relations and social life.

Due to their dynamic nature and specific appeal to certain audiences, computer games and especially games played on Internet enabled platforms provide the ideal vehicle for Internet advertising. Not only is it possible for an advertiser to target directly a specific group of customers, but also advertisements optionally are incorporated directly into the computer games, enabling something akin to the well-known concept of product placement. In such a system, a game is running on a computer that is connected to the Internet. Throughout the playing of the game, the game software contacts a set of ad servers to retrieve advertising content that is available for being displayed to the gamer during game play. The data and advertising content is transferred using HTTP protocols over the Internet. Optionally, the advertising content is cached locally to the game, and throughout the playing of the game the game software contacts a set of ad servers to retrieve a list of advertising content, selected from the cached advertising content, that is available for display to the gamer during game play.

Of course, a computer game containing a multiplicity of advertising spots may have more spots than can be utilized by a particular advertisement service provider. It would therefore be advantageous for the advertisement service provider, having reserved an advertising enabled game, to be able to re-sell or make available any unused spots to at least another advertisement service provider. However, advertisement service providers (ADSPs) typically view the content they place as having proprietary value. In a broker mediated advertisable gaming environment, it therefore is important to protect the interests of all ADSPs. For instance, it is important that a wholesaling advertising broker is not able to view another ADSP's advertising content without seeing it in situ in an advertising enabled game. Furthermore, it is essential that no ADSP be able to modify or otherwise affect another ADSP's advertising content.

### SUMMARY OF EMBODIMENTS OF THE INVENTION

In accordance with an aspect of the instant invention there is provided a method for managing advertising content delivery in a gaming environment, comprising: associating a plurality of advertising spots of an advertising enabled game with a first advertising service provider (ADSP), the first ADSP in communication with a communications network; using an encryption key, securing advertising content data of a second ADSP, the second ADSP in communication with the communications network; and, via the communications network, providing the secured advertising content data of the second ADSP for being displayed at one of the plurality of advertising spots associated with the first ADSP.

In accordance with another aspect of the instant invention there is provided a method for managing advertising content delivery in a gaming environment, comprising: providing a server in communication with a communications network; receiving at the server, via the communications network, advertising content data relating to a first advertising service provider (ADSP), the first ADSP also in communication with the communications network; securing the advertising content data relating to the first ADSP using an encryption key; and, providing the secured advertising content data from the server to a second ADSP, via the communications network, the second ADSP also in communication with the communications network.

In accordance with another aspect of the instant invention there is provided a method for managing advertising content delivery in a gaming environment, comprising: providing a server in communication with a communications network; retrievably storing secured advertising content data within a storage portion of the server, the secured advertising content data encrypted using a private encryption key; providing an advertising enabled game in communication with the communications network, the advertising enabled game containing a plurality of advertising spots for displaying advertising content therein; providing the secured advertising content data from the server to the advertising enabled game via the communications network; and, using a public key associated with the private key, performing one of decrypting and validating the secured advertising content data.

In accordance with another aspect of the instant invention there is provided a method for managing advertising content delivery in a gaming environment, comprising: providing an advertising enabled game in communication with a communications network, the advertising enabled game including a plurality of advertising spots for displaying advertising content therein; receiving secured advertising content data via the communications network, the secured advertising content data being secured using a private encryption key; retrieving a public key that is associated with the private encryption key; and, using the public key to one of decrypt and validate the secured advertising content data.

In accordance with another aspect of the instant invention there is provided a method for managing advertising content delivery in a gaming environment, comprising: providing a server in communication with a communications network; receiving at the server, via the communications network, secured advertising content data, the secured advertising content data relating to a first advertising service provider (ADSP) that also is in communication with the communications network; retrievably storing the secured advertising content data within a storage portion of the server; and, providing the secured advertising content data via the communications network, from the server to an advertising enabled game that also is in communication with the communications network, the advertising enabled game including a plurality of advertising spots for displaying advertising content therein.

In accordance with another aspect of the instant invention there is provided a method for managing advertising content delivery in a gaming environment, comprising: associating a plurality of advertising spots of an advertising enabled game with a first advertising service provider (ADSP), the first ADSP in communication with a communications network; using an encryption key, securing advertising content data from tampering; and, via the communications network, providing the secured advertising content data of for being impressed within one of the plurality of advertising spots associated with the first ADSP.

In accordance with an aspect of the instant invention there is provided a broker mediated advertisable gaming environment having gaming sites and advertising sites connected to an Internet protocol wide area network. The gaming environment comprises a broker site connected to an internet protocol wide area network for registering games provided from gaming sites and for licensing registered games for advertising to advertising sites, whereby the broker site maintains an inventory of characteristics of registered games, the characteristics relevant for advertising.

In accordance with another aspect of the instant invention there is provided a method for allowing a leaseholder advertisement service provider to offer enabled spots within a game for use by at least another advertisement service provider.

In accordance with another aspect of the instant invention there is provided an advertising broker that acts as an impartial broker between the wholesaling advertisement service provider and the at least another advertisement service provider.

In accordance with another aspect of the instant invention there is provided a method for allowing an advertising broker to generate a private/public key pair to be used to secure content approved for inclusion in an advertising enabled game.

In accordance with another aspect of the instant invention there is provided a method for allowing content from at least an advertisement service provider to be stored in the database of a wholesaling advertisement service provider.

### BRIEF DESCRIPTION OF THE DRAWINGS

Embodiments of the instant invention will now be described in conjunction with the following drawings, in which:

FIG. 1 is a high-level block diagram of a broker mediated advertisable gaming system;

FIG. 2 is a simplified flow diagram of a method according to an embodiment of the instant invention;

FIG. 3 is a simplified flow diagram of another method according to an embodiment of the instant invention;

FIG. 4 is a simplified flow diagram of another method according to an embodiment of the instant invention;

FIG. 5 is a simplified flow diagram of another method according to an embodiment of the instant invention;

FIG. 6 is a simplified flow diagram of another method according to an embodiment of the instant invention; and,

FIG. 7 is a simplified flow diagram of another method according to an embodiment of the instant invention.

### DETAILED DESCRIPTION OF EMBODIMENTS OF THE INVENTION

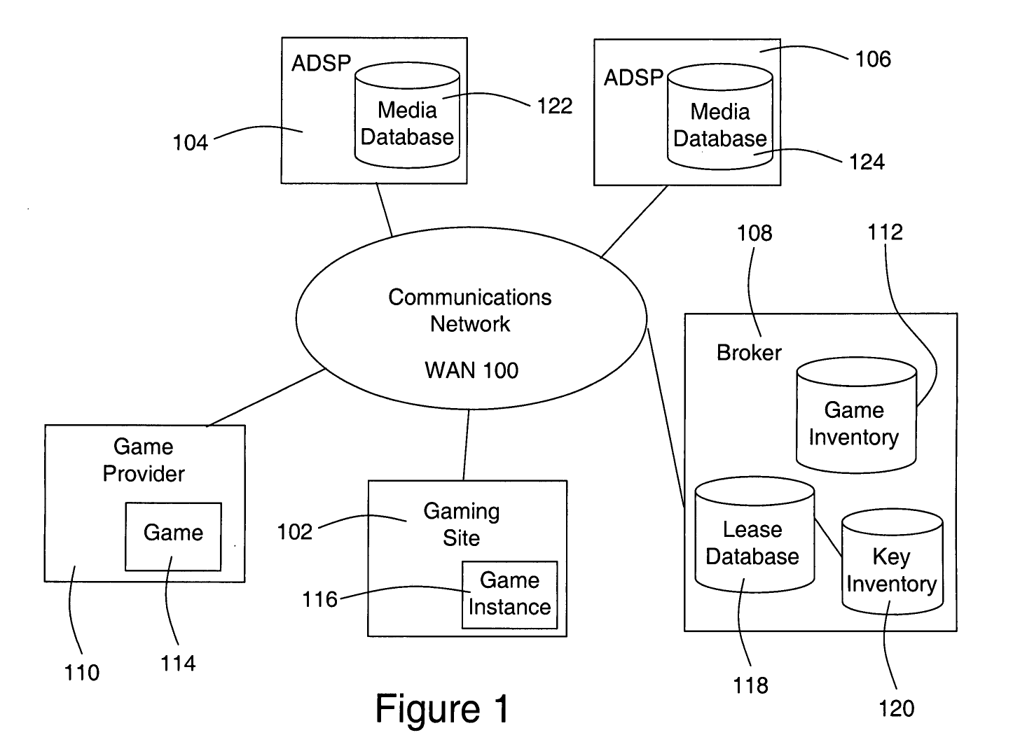

Referring to FIG. 1, shown is a high-level block diagram of a broker mediated advertisable gaming system. A computer system of gaming site 102 is connected to a communications network, for instance Internet Protocol Wide Area Network (WAN) 100. Advertising service provider (ADSP) 104 and ADSP 106 also are connected to WAN 100. ADSP 104 and ADSP 106 implement one or more ad campaigns at a time. In the case of plural ad campaigns, ADSP 104 and ADSP 106 each schedule delivery of advertising content that is provided by different advertisers, to a limited number of available spots within instances of a game at gaming site 102. Clearly, it is a complex task managing and scheduling advertising content that is selected from a plurality of different advertising campaigns, which are being implemented by a plurality of ADSPs, for display at spots appearing within instances of a game at gaming site 102. Advertising broker site 108, which also is connected to WAN 100, acts as an intermediary between the plurality of ADSPs and gaming site 102, as described for instance in U.S. Provisional Patent Application 60/636,543, filed on Dec. 17, 2004 and in a co-pending U.S. patent application claiming priority therefrom and filed on Dec. 19, 2005, the entire contents of both of which are incorporated herein by reference.

A game provider 110 also is connected to WAN 100. The game provider 110 provides an advertising enabled game. For instance, when the game is in execution on a computer system of gaming site 102, information relevant to advertising is provided to the game via WAN 100, from one or both of ADSP 104 and ADSP 106. Based on the provided information, advertising content is displayed at spots within a game instance 116 of the advertising enabled game.

Optionally, ADSP 104 reserves an advertising enabled game 114 listed as available in the game inventory 112 of advertising broker site 108, thereby becoming the leaseholder. Advertising broker site 108 generates in lease database 118 a unique identifier for the lease. ADSP 104 subsequently notifies advertising broker site 108 that it is going to wholesale some of the enabled spots in game 114. Advertising broker site 108 marks the wholesaled spots associated with game 114 in the game inventory 112 as being available.

ADSP 106 subsequently desires to schedule content for some of the wholesaled spots in game 114, via advertising broker site 108. Prior to the lease schedule, both ADSP 104 and ADSP 106 submit content to advertising broker site 108 for approval. If content needs to be approved by the game provider 110, then advertising broker site 108 submits the content to game provider 110, and if approved, game provider 110 returns the content to advertising broker site 108, or simply returns an approval message to advertising broker site 108.

Once the content from an ADSP 104 or 106 is approved, advertising broker site 108 uses a private/public key pair, for instance asymmetric keys as used in RSA, DSA, or PGP, to secure the content data. Securing of content data is well known in the art of computer security and is optionally performed using symmetric keys or asymmetric keys. Further, securing of the data is optionally performed for preventing access to the data for the purpose of obfuscation. Alternatively, securing of the data is performed for preventing tampering such as certifying of the data. Further alternatively, securing of the data is performed to indicate data validation by third parties digitally signing the data. Each of these concepts is well understood to one of skill in the art of computer security.

In many encryption schemes, the intent is to ensure one of only the intended recipient being able to read the data and a recipient of the data being able to verify the data as “intended.” To obfuscate data, it is encrypted using a public key of the intended recipient. Only the recipient having their private key can decrypt the data, given that the private key is uncompromised. However, when securing publicly visible data against third-party tampering, the definition of public and private are typically reversed so that only one source has the ability to encrypt the data—digitally sign or certify the data, but anyone can verify the digital signature. To this end, a private key known only to advertising broker site 108 is used to secure the data relating to the content, preferably by signing data relating to the content. A corresponding public key is made available to game instance 116, for use in validating the data relating to the content. One of skill in the art will readily envisage other ways to ensure that content cannot be tampered with after approval by the game provider 110.

Referring still to FIG. 1, the advertising broker site 108 stores the public key that is used to secure the approved content of an ADSP in a key inventory 120 and stores an associated private key of the pair in its secure private key data store. Typically, the key pair is at least unique to a given lease, and optionally is stored on a per ADSP basis. For instance, if content provided by an ADSP is not intended to be visible to any other ADSP associated with the lease, then a unique private/public key pair is generated for each ADSP, and the key pair is stored in the key inventory 120 on a per ADSP basis. Otherwise a single private/public key pair optionally is used for all ADSP's associated with a lease. When the private key is used for digitally signing of documents, typically a same key is used for signing documents.

After securing the approved content of ADSP 106, based on the appropriate private key, advertising broker site 108 submits the secured content to a hosting ADSP. Typically, the leaseholder ADSP hosts all secured content associated with the lease. Accordingly, in the instant non-limiting example the approved and secured content of ADSP 106 is submitted to ADSP 104 for hosting thereby. As shown in FIG. 1, the hosting ADSP 104 stores the secured content in media database 122. Optionally, if advertising broker site 108 provides ADSP 104 with the corresponding public key then ADSP 104 is able to decrypt any content that it is hosting and that was secured by a corresponding private key.

Optionally, if ADSP 106 is configured to host its own content then the advertising broker site 108 secures the approved content of ADSP 106 based on the private key and submits the secured content to ADSP 106 for hosting thereby. As shown in FIG. 1, the hosting ADSP 106 stores the secured content in media database 124. Optionally, if advertising broker site 108 provides ADSP 106 with the corresponding public key then ADSP 106 is able to decrypt any content that it is hosting and that was secured by a corresponding private key.

Optionally, advertising broker site 108 provides each ADSP with a public key, such that a hosting ADSP is able to retrieve content from its media database. Alternatively, the public key is retrieved from a public key database. Of course, the hosting ADSP is able only to decrypt and/or validate content that was secured by advertising broker site 108 using a private key that is associated with the public key.

Optionally, advertising broker site 108 provides each ADSP with a public key, such that a non-hosting ADSP is able to retrieve content from a hosting ADSP's media database, assuming that the content is first exposed by the hosting ADSP. Of course, the non-hosting ADSP is able only to decrypt and/or validate content that was secured by advertising broker site 108 using a private key that is associated with the public key.

When a game instance 116 contacts the advertising broker site 108, the game instance 116 fetches lease ID and a URL of any hosting ADSP, as well as a table of appropriate public keys from the key inventory 120. If the advertising broker site 108 stores the keys on a per ADSP basis, then the table contains sufficient information to associate an ADSP with appropriate public keys.

In the instant example, the game instance 116 then retrieves a table of contents from hosting ADSP 104. If the public key pairs are stored in key inventory 120 on a per ADSP basis, then each advertising spot's entry in the table of contents includes an identifier of the ADSP that originally submitted the content of the spot. Though this limits release of the public keys, the security of the digital signatures is not compromised by general or public release of the public key portion since the Broker remains the only party with the private key and hence the only party able to digitally sign content using that key pair.

The game instance 116 decrypts and/or validates secured content data based on the public key that is indexed according to an ADSP identifier. Secured content data that cannot be decrypted or validated indicates that the data has been corrupted, either in transit or in the hosting ADSP media database, and that therefore the entire table of contents is to be considered invalid. Typically, the secured content need only be decrypted and/or validated once, and thereafter placed in a validated cache so as to prevent subsequent in-game tampering with the media.

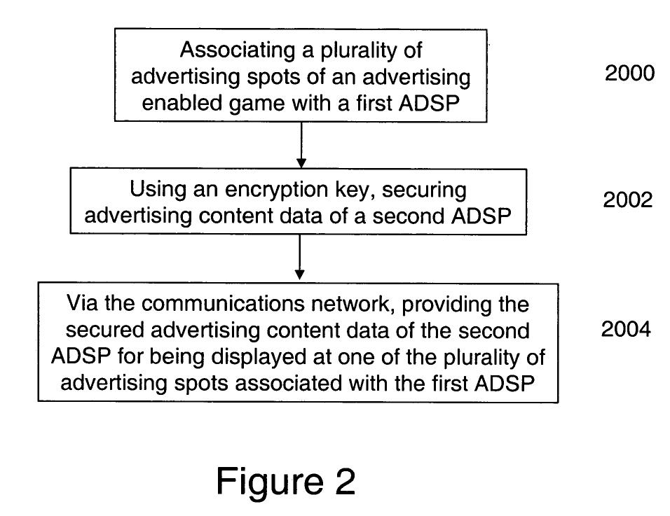

Referring now to FIG. 2, shown is a simplified flow diagram of a method according to an embodiment of the instant invention. Here a first ADSP wholesales out a number of advertising spots to a second ADSP. The second ADSP has each dynamic content for being delivered to the games digitally signed by the first ADSP and hosted thereby. Further digital signatures are also provided for the content. Alternatively, only the further digital signatures are provided. Thus, the first ADSP hosts advertising content provided by the second ADSP. This is not highly desirable.

Referring still to FIG. 2, at step 2000 a plurality of advertising spots of an advertising enabled game is associated with a first advertising service provider (ADSP), the first ADSP in communication with a communications network. At step 2002 using an encryption key, securing advertising content data of a second ADSP, the second ADSP in communication with the communications network. At step 2004, via the communications network, the secured advertising content data of the second ADSP is provided for being displayed at one of the plurality of advertising spots associated with the first ADSP.

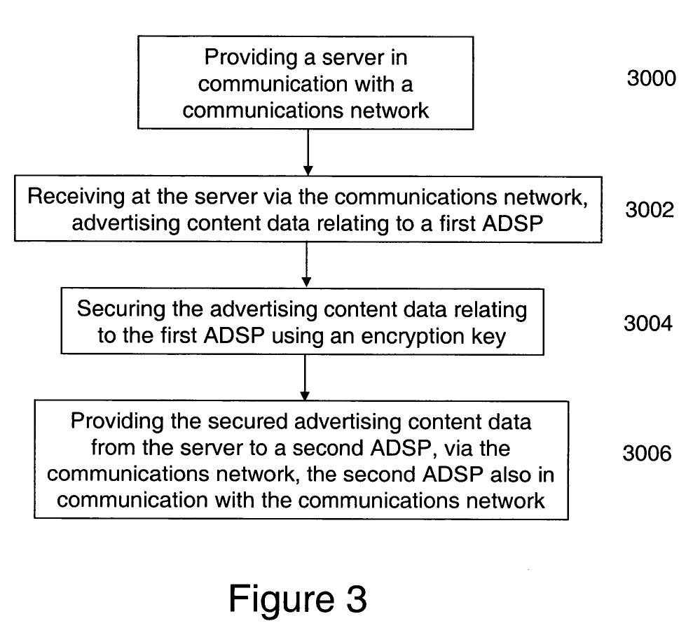

Referring now to FIG. 3, shown is a simplified flow diagram of a method according to an embodiment of the instant invention. Here a first ADSP wholesales out a number of advertising spots to a second ADSP. The second ADSP digitally signs each dynamic content for being delivered to the games and includes within the digital signatures a digitally signed datum indicating that the ad hosting has been changed to the second ad sp. This datum is digitally signed by the first ADSP. Alternatively, this datum is digitally signed by a broker server. Further digital signatures are also provided for the content. Alternatively, only the further digital signatures are provided. Thus, upon receiving the advertising content at a video game, it is verifiable that the content comes from an approved content provider and is in accordance with business practices to ensure payment for the advertising content and to prevent tampering with video game content.

Referring still to FIG. 3, at step 3000 a server is provided in communication with a communications network. At step 3002, advertising content data relating to a first advertising service provider (ADSP) is received at the server via the communications network. In particular, the first ADSP is also in communication with the communications network. At step 3004 the advertising content data relating to the first ADSP is secured using an encryption key. At step 3006 the secured advertising content data is provided from the server to a second ADSP, via the communications network, the second ADSP also in communication with the communications network.

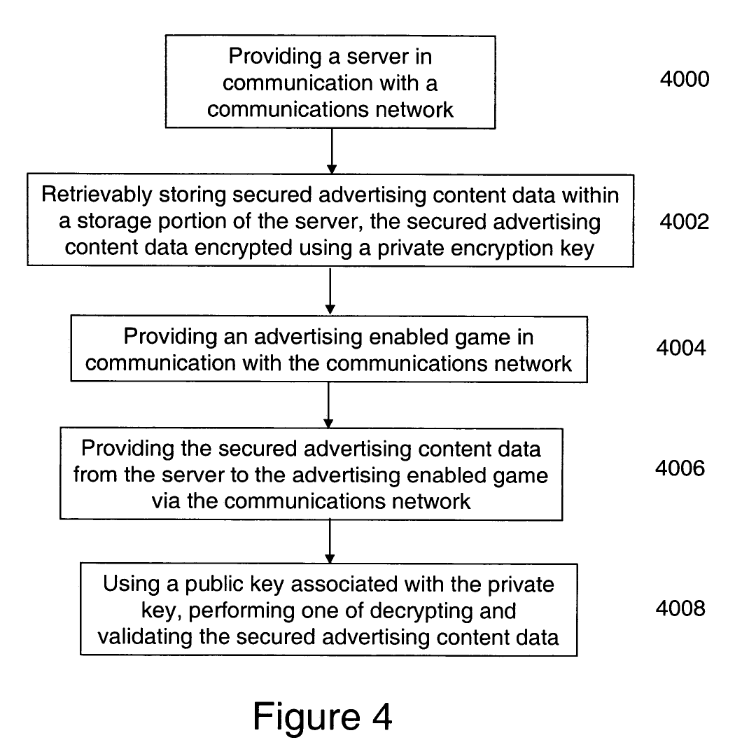

Referring now to FIG. 4, shown is a simplified flow diagram of a method according to an embodiment of the instant invention. Here a first ADSP wholesales out a number of advertising spots to a second ADSP. The second ADSP digitally signs each dynamic content for being delivered to the games. Further digital signatures are also provided for the content. Alternatively, only the further digital signatures are provided. Further, the broker server adjusts a content deliverer for the wholesale content to be the second ADSP while maintaining the billing information and contractual data relating to the first ADSP. As such, when the data is delivered from the second ADSP, the video game system recognizes it as approved content from an approved provider, yet the invoicing and so forth is as it should be.

Referring still to FIG. 4, at step 4000 a server is provided in communication with a communications network. At step 4002 the secured advertising content data is retrievably stored within a storage portion of the server, the secured advertising content data encrypted using a private encryption key. At step 4004 an advertising enabled game is provided in communication with the communications network, the advertising enabled game containing a plurality of advertising spots for displaying advertising content therein. At step 4006 the secured advertising content data is provided from the server to the advertising enabled game via the communications network. At step 4008, a public key associated with the private key is used for one of decrypting and validating the secured advertising content data.

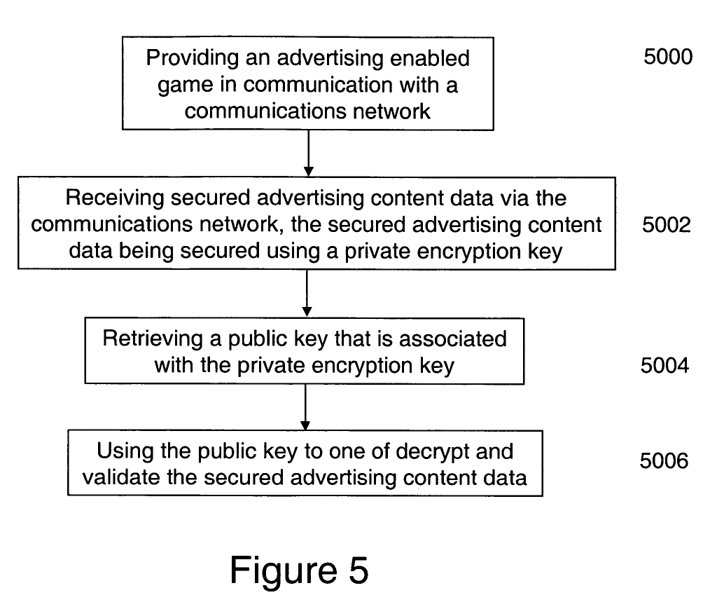

Referring now to FIG. 5, shown is a simplified flow diagram of another method according to an embodiment of the instant invention. Here, a plurality of partners each digitally signs the content along with digitally signed data about the advertising content. Thus, when dynamic content is received including digital signatures, it is possible to verify that each partner has accepted the digital content and on what terms the content is accepted. Thus, for example, a broker server verifies each digital signature and ensures that all conditions are met before providing the dynamic content to a video game along with appropriate digital certification thereof. Alternatively, the video game receives the dynamic content and verifies the digital signatures to prevent impressing of dynamic content upon a gamer absent necessary conditions and approvals.

Referring still to FIG. 5, at step 5000 an advertising enabled game is provided in communication with a communications network, the advertising enabled game including a plurality of advertising spots for displaying advertising content therein. At step 5002 secured advertising content data is received via the communications network, the secured advertising content data being secured using a private encryption key. At step 5004 a public key that is associated with the private encryption key is retrieved. At step 5006 the public key is used to one of decrypt and validate the secured advertising content data.

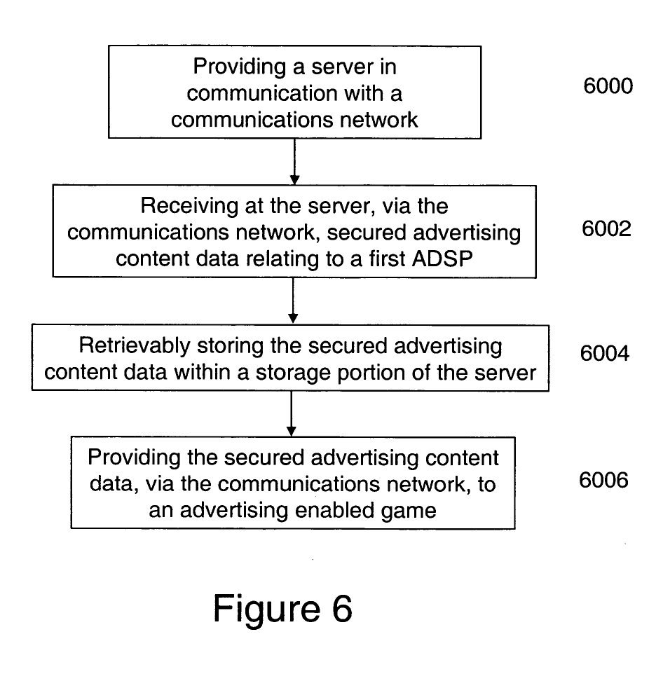

Referring now to FIG. 6, shown is a simplified flow diagram of another method according to an embodiment of the instant invention. At step 6000 a server is provided in communication with a communications network. At step 6002 secured advertising content data is received at the server, via the communications network. In particular, the secured advertising content data relates to a first advertising service provider (ADSP) that also is in communication with the communications network. At step 6004 the secured advertising content data is retrievably stored within a storage portion of the server. At step 6006 the secured advertising content data is provided via the communications network, from the server to an advertising enabled game that also is in communication with the communications network. In particular, the advertising enabled game includes a plurality of advertising spots for displaying advertising content therein.

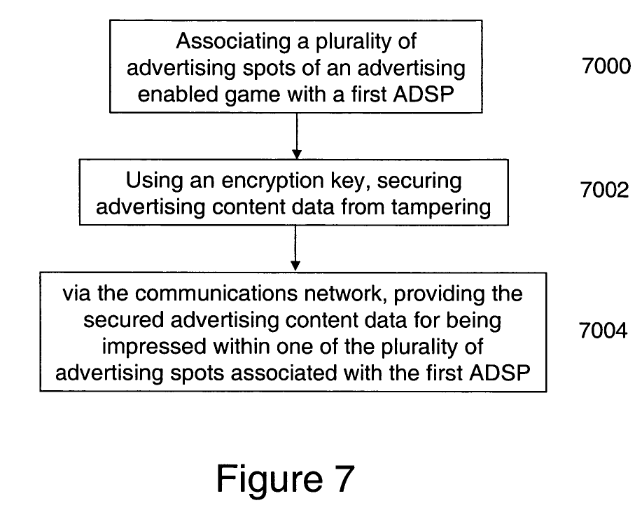

Referring now to FIG. 7, shown is a simplified flow diagram of another method according to an embodiment of the instant invention. At step 7000 a plurality of advertising spots of an advertising enabled game are associated with a first advertising service provider (ADSP), the first ADSP being in communication with a communications network. At step 7002 an encryption key is used for securing advertising content data from tampering. At step 7004 the secured advertising content data is provided, via the communications network, for being impressed within one of the plurality of advertising spots associated with the first ADSP.

Of course, the reference numerals referred to in the discussion of the methods according to FIGS. 2-7 are not intended to imply any particular order. In many cases method steps are optimally performed in an order that differs from an order that is presented in the specific, and non-limiting, examples of FIGS. 2-7.

Numerous other embodiments may be envisaged without departing from the spirit and scope of the instant invention. All specific examples have been provided for illustrative purposes only and are not intended to be limiting in any way.

What is claimed is:

1. A method for managing advertising content delivery in a gaming environment, comprising:
associating a plurality of advertising spots of an advertising enabled game with a first advertising service provider (ADSP), the first ADSP in communication with a communications network;
using an encryption key, securing advertising content data of a second ADSP, the second ADSP in communication with the communications network; and,
via the communications network, providing the secured advertising content data of the second ADSP for being displayed at one of the plurality of advertising spots associated with the first ADSP.

2. A method according to claim 1, wherein the one of the plurality of advertising spots is an advertising spot that is not used for displaying advertising content data of the first ADSP.

3. A method according to claim 1, wherein providing the secured advertising content data of the second ADSP comprises retrievably storing the secured advertising content data of the second ADSP within in a storage area of the first ADSP.

4. A method according to claim 1, wherein providing the secured advertising content data of the second ADSP comprises retrievably storing a locally persistent copy of the secured advertising content data at the advertising enabled game.

5. A method according to claim 1, comprising providing an advertising broker site in communication with the communications network.

6. A method according to claim 5, wherein securing advertising content data of the second ADSP is performed by the advertising broker site using an encryption key thereof.

7. A method according to claim 6, wherein the encryption key is a private encryption key.

8. A method according to claim 7, comprising providing a public key associated with the private encryption key, from the advertising broker site to at least one of the first ADSP, the second ADSP and the advertising enabled game.

9. A method according to claim 8, wherein the advertising enabled game uses the provided public key to at least one of decrypt and validate the provided secured advertising content data of the second ADSP, prior to displaying the secured advertising content data of the second ADSP at the one of the plurality of advertising spots.

10. A method according to claim 1, comprising providing a game processing hardware provider site in communication with the communications network wherein securing advertising content data of the second ADSP is performed by the game processing hardware provider site.

11. A method according to claim 1, comprising providing a game provider site in communication with the communications network wherein securing advertising content data of the second ADSP is performed by the game provider site.

12. A method according to claim 11, wherein securing the advertising content data of the second ADSP comprises approving the advertising content data of the second ADSP for being displayed at the one of the plurality of advertising spots.

13. A method according to claim 12, comprising providing a public key associated with the private encryption key, from the game provider site to at least one of the first ADSP, the second ADSP and the advertising enabled game.

14. A method according to claim 13, wherein the advertising enabled game uses the provided public key to at least one of decrypt and validate the provided secured advertising content data of the second ADSP, prior to displaying the secured advertising content data of the second ADSP at the one of the plurality of advertising spots.

15. A method according to claim 1 comprising:
providing the secured advertising content data to the second ADSP; and,
retrievably storing the secured advertising content data within a storage portion of the second ADSP.

16. A method according to claim 15, wherein the secured advertising content data is for being displayed at an advertising spot of an advertising enabled game.

17. A method according to claim 16, comprising providing a public key associated with the private encryption key, from the advertising broker site to the advertising enabled game for use in one of decrypting and validating the secured advertising content data.

18. A method for managing advertising content delivery in a gaming environment, comprising:
providing a server in communication with a communications network;
receiving at the server, via the communications network, advertising content data relating to a first advertising service provider (ADSP), the first ADSP also in communication with the communications network;
securing the advertising content data relating to the first ADSP using an encryption key; and,
providing the secured advertising content data from the server to a second ADSP, via the communications network, the second ADSP also in communication with the communications network.

19. A method according to claim 18, wherein the server is a server of an advertising broker site.

20. A method according to claim 19, wherein the encryption key is a private encryption key.

21. A method according to claim 20, comprising providing a public key associated with the private encryption key, from the advertising broker site to at least one of the first ADSP and the second ADSP, via the communications network.

22. A method according to claim 20, wherein the secured advertising content data is for being displayed at an advertising spot of an advertising enabled game.

23. A method according to claim 22, comprising providing a public key associated with the private encryption key, from the advertising broker site to the advertising enabled game for use in one of decrypting and validating the secured advertising content data.

24. A method according to claim 18, wherein the server is a server of a game provider site.

25. A method according to claim 24, wherein the encryption key is a private encryption key.

26. A method according to claim 25, comprising providing a public key associated with the private encryption key, from the game provider site to at least one of the first ADSP and the second ADSP, via the communications network.

27. A method according to claim 25, wherein the secured advertising content data is for being displayed at an advertising spot of an advertising enabled game.

28. A method according to claim 27, comprising providing a public key associated with the private encryption key, from the game provider site to the advertising enabled game for use in one of decrypting and validating the secured advertising content data.

29. A method for managing advertising content delivery in a gaming environment, comprising:
providing a server in communication with a communications network;
retrievably storing secured advertising content data within a storage portion of the server, the secured advertising content data encrypted using a private encryption key;
providing an advertising enabled game in communication with the communications network, the advertising enabled game containing a plurality of advertising spots for displaying advertising content therein;
providing the secured advertising content data from the server to the advertising enabled game via the communications network; and,
using a public key associated with the private key, performing one of decrypting and validating the secured advertising content data.

30. A method according to claim 29, comprising displaying the one of decrypted and validated secured advertising data at one of the plurality of advertising spots.

31. A method according to claim 29, wherein the server is a server of a first advertising service provider (ADSP).

32. A method according to claim 31, wherein the plurality of advertising spots is associated with the first ADSP.

33. A method according to claim 32, wherein the secured advertising content data is associated with a second different ADSP.

34. A method according to claim 33, comprising providing an advertising broker site in communication with the communications network, wherein the advertising broker site uses the private encryption key to secure unsecured advertising content data received from the second different ADSP.

35. A method according to claim 34, comprising providing the secured advertising content data from the advertising broker site to the server of the first ADSP, via the communications network.

36. A method according to claim 33, comprising providing a game provider site in communication with the communications network, wherein the game provider site uses the private encryption key to secure unsecured advertising content data received from the second ADSP.

37. A method according to claim 36, comprising providing the secured advertising content data from the game provider site to the server of the first ADSP, via the communications network.

38. A method for managing advertising content delivery in a gaming environment, comprising:
providing an advertising enabled game in communication with a communications network, the advertising enabled game including a plurality of advertising spots for displaying advertising content therein;
receiving secured advertising content data via the communications network, the secured advertising content data being secured using a private encryption key;
retrieving a public key that is associated with the private encryption key; and,
using the public key to one of decrypt and validate the secured advertising content data.

39. A method according to claim 38, comprising displaying the one of decrypted and validated secured advertising data at one of the plurality of advertising spots.

40. A method according to claim 38, wherein the plurality of advertising spots is associated with a first ADSP.

41. A method according to claim 40, wherein the secured advertising content data is associated with a second different ADSP.

42. A method according to claim 41, comprising providing an advertising broker site in communication with the communications network, wherein the advertising broker site uses the private encryption key to secure unsecured advertising content data received from the second different ADSP.

43. A method according to claim 42, comprising providing the secured advertising content data from the advertising broker site to a server of the first ADSP, via the communications network.

44. A method according to claim 41, comprising providing a game provider site in communication with the communications network, wherein the game provider site uses the private encryption key to secure unsecured advertising content data received from the second different ADSP.

45. A method according to claim 44, comprising providing the secured advertising content data from the game provider site to a server of the first ADSP, via the communications network.

46. A method for managing advertising content delivery in a gaming environment, comprising:
providing a server in communication with a communications network;
receiving at the server, via the communications network, secured advertising content data, the secured advertising content data relating to a first advertising service provider (ADSP) that also is in communication with the communications network;
retrievably storing the secured advertising content data within a storage portion of the server; and,
providing the secured advertising content data via the communications network, from the server to an advertising enabled game that also is in communication with the communications network, the advertising enabled game including a plurality of advertising spots for displaying advertising content therein.

47. A method according to claim 46, wherein the server is a server of a second ADSP.

48. A method according to claim 47, wherein the plurality of advertising spots are associated with the second ADSP, and wherein the first ADSP obtains access to at least one of the plurality of advertising spots from the second ADSP on a wholesale basis.

49. A method according to claim 46, wherein the server receives the secured advertising content data from an advertising broker site.

50. A method according to claim 49, comprising securing advertising content data at the advertising brokers site using an encryption key, the advertising content data provided from the first ADSP.

51. A method according to claim 46 comprising securing advertising content data at the game provider site using an encryption key private to the game provider.

52. A method according to claim 46 comprising securing advertising content data at the game hardware provider site using an encryption key private to the game hardware provider.

53. A method for managing advertising content delivery in a gaming environment, comprising:
associating a plurality of advertising spots of an advertising enabled game with a first advertising service provider (ADSP), the first ADSP in communication with a communications network;
using an encryption key, securing advertising content data from tampering; and,
via the communications network, providing the secured advertising content data for being impressed within one of the plurality of advertising spots associated with the first ADSP.
